(19) United States
(12) Patent Application Publication
(10) Pub. No.: US 2025/0197775 A1
(43) Pub. Date: Jun. 19, 2025

(54) UNIT DOSE DETERGENT COMPOSITIONS AND METHODS OF USING THE SAME

(71) Applicant: HENKEL AG & CO. KGAA, Düsseldorf (DE)

(72) Inventors: Daniel PIORKOWSKI, Fairfield, CT (US); Janet COOPE-EPSTEIN, Trumbull, CT (US)

(21) Appl. No.: 18/970,753

(22) Filed: Dec. 5, 2024

Related U.S. Application Data
(60) Provisional application No. 63/611,984, filed on Dec. 19, 2023.

(51) Int. Cl. C11D 3/22; C11D 1/29; C11D 1/72; C11D 1/831; C11D 3/00; C11D 3/04; C11D 3/20; C11D 3/37; C11D 3/386; C11D 17/04

(52) U.S. Cl. CPC C11D 3/221; C11D 1/29; C11D 1/72; C11D 3/0036; C11D 3/044; C11D 3/2065; C11D 3/2068; C11D 3/2075; C11D 3/3723; C11D 3/3753; C11D 3/38618; C11D 17/043; C11D 1/831; C11D 2111/12

(57) ABSTRACT

Disclosed are unit dose detergent compositions including a pouch having at least one chamber, the pouch made of a water-soluble material, and a detergent composition encapsulated within the at least one chamber, the detergent composition having a sugar amine, a non-aqueous solvent, one or more nonionic and/or anionic surfactants and water.

### CROSS REFERENCE TO RELATED APPLICATIONS

This application claims the benefit of U.S. Provisional Patent App. No. 63/611,984, filed Dec. 19, 2023, the disclosure of which is hereby incorporated by reference herein.

### FIELD OF THE INVENTION

The disclosure generally relates to a unit dose product comprising a liquid detergent composition and methods of using the same. More specifically, the disclosure relates to a unit dose product comprising a detergent composition that contains a sugar amine.

### BACKGROUND

Unit dose containing liquid laundry detergent compositions contain surfactants to have good cleaning performance. However, many surfactant compositions cause skin and eye irritation. Consumers generally prefer mild liquid detergent formulations. While several products currently on the market claim to be mild, there is a still a need to develop improved mild liquid detergent formulations that have good cleaning performance in a unit dose form.

### SUMMARY OF THE INVENTION

Various aspects of the disclosure are directed to unit dose products comprising liquid detergent compositions and methods of using the same.

In some instances, a first aspect of the disclosure can be described as a unit dose detergent product comprising a pouch comprising at least one chamber, where the pouch is made of water-soluble material, and a detergent composition encapsulated within at least one chamber.

In some instances, a second aspect of the disclosure can be described as a unit dose detergent product according to the first aspect, wherein the detergent composition comprises a sugar amine, a non-aqueous solvent, one or more nonionic and/or anionic surfactants, and water.

In some instances, a third aspect of the disclosure can be described as a unit dose detergent product comprising a detergent composition according to the first or second aspect, wherein the sugar amine is in an amount ranging from about 0.025 to about 2 wt % of the detergent composition, the non-aqueous solvent is in an amount ranging from about 15 to about 65 wt % of the detergent composition, and the one or more nonionic and/or anionic surfactants is in an amount ranging from about 15 to about 55 wt % of the detergent composition.

In some instances, a fourth aspect of the disclosure can be described as a unit dose detergent product comprising a detergent composition according to any one of the first through third aspects, wherein the detergent composition further comprises a fatty acid. In some instances, the fatty acid is in an amount ranging from about 1 to about 10 wt % of the detergent composition.

In some instances, a fifth aspect of the disclosure can be described as a unit dose detergent product comprising a detergent composition according to any one of the first through fourth aspects, wherein the detergent composition further comprises a lauryl sulfate and/or a lauryl ether sulfate (also commonly referred to as a laureth sulfate). In some instances, the lauryl sulfate and/or the lauryl ether sulfate is in an amount ranging from about 2 to about 8 wt % of the detergent composition.

In some instances, a sixth aspect of the disclosure can be described as a unit dose detergent product comprising a detergent composition according to any one of the first through fifth aspects, wherein the detergent composition further comprises a bittering agent. In some instances, the bittering agent is in an amount ranging from about 0.01 to about 0.5 wt % of the detergent composition.

In some instances, a seventh aspect of the disclosure can be described as a unit dose detergent product comprising a detergent composition according to any one of the first through sixth aspects, wherein the detergent composition further comprises a denatured alcohol in an amount ranging from about 0.5 to about 6 wt % of the detergent composition.

In some instances, an eighth aspect of the disclosure can be described as a unit dose detergent product comprising a detergent composition according to any one of the first through seventh aspects, wherein the detergent composition further comprises a chelating agent. In some instances, the chelating agent is in an amount from about 0.1 to about 2 wt % of the detergent composition.

In some instances, a ninth aspect of the disclosure can be described as a unit dose detergent product comprising a detergent composition according to any one of the first through eighth aspects, wherein the sugar amine is glucosamine, sorbitol amine, a glucose diamine, a salt thereof, or any combination or any of the foregoing.

In some instances, a tenth aspect of the disclosure can be described as a unit dose detergent product comprising a detergent composition according any one of the first through ninth aspects, wherein the sugar amine is glucosamine HCl.

In some instances, an eleventh aspect of the disclosure can be described as a unit dose detergent product comprising a detergent composition according to any one of the first through tenth aspects, wherein the sugar amine is in an amount from about 0.25 to about 0.75 wt % of the detergent composition.

In some instances, a twelfth aspect of the disclosure can be described as a unit dose detergent product comprising a detergent composition according to any one of the first through eleventh aspects, wherein the detergent composition further comprises at least one of a protease, a mannanase, and an amylase.

In some instances, a thirteenth aspect of the disclosure can be described as a unit dose detergent product comprising a detergent composition according to any one of the first through twelfth aspects, wherein the detergent composition further comprises a strong base. In some instances, the strong base is in an amount ranging from about 0.5 to about 5 wt % of the detergent composition. In some instances, the strong base is sodium hydroxide.

In some instances, a fourteenth aspect of the disclosure can be described as a unit dose detergent product comprising a detergent composition according to any one of the first through thirteenth aspects, wherein the water-soluble material is a polyvinyl alcohol.

In some instances, a fifteenth aspect of the disclosure can be described as a unit dose detergent product comprising a detergent composition according to any one of the first through fourteenth aspects, wherein the detergent composition has a pH ranging from about 6.5 to about 10.

In some instances, a sixteenth aspect of the disclosure can be described as a unit dose detergent product comprising a detergent composition according to any one of the first through fifteenth aspects, wherein the detergent composition further comprises a polyethylene imine ethoxylate, a polyethylene imine propoxylate or a polyethylene imine ethoxylate/propoxylate.

In some instances, a seventeenth aspect of the disclosure can be described as a unit dose detergent product comprising a detergent composition according to any one of the first through sixteenth aspects, wherein the detergent composition further comprises an anti-redeposition polymer.

In some instances, an eighteenth aspect of the disclosure can be described as a unit dose detergent product comprising a detergent composition according to any one of the first through seventeenth aspects, wherein the non-aqueous solvent comprises glycerin.

In some instances, a nineteenth aspect of the disclosure can be described as a unit dose detergent product comprising a detergent composition according to any one of the first through eighteenth aspects, wherein the non-aqueous solvent comprises a polyethylene glycol.

In some instances, a twentieth aspect of the disclosure can be described as a unit dose detergent product comprising a detergent composition according to the nineteenth aspect, where the polyethylene glycol has a molecular weight ranging from about 200 to about 1000 g/mol.

In some instances, a twenty-first aspect of the disclosure can be described as a unit dose detergent product comprising a detergent composition according to the nineteenth aspect, where the polyethylene glycol has a molecular weight ranging from about 200 to about 800 g/mol.

In some instances, a twenty-second aspect of the disclosure can be described as a unit dose detergent product comprising a detergent composition according to the nineteenth aspect, where the polyethylene glycol has a molecular weight of about 400 g/mol.

In some instances, a twenty-third aspect of the disclosure can be described as a unit dose detergent product comprising a detergent composition according to any one of the first through twenty-second aspects, wherein the detergent composition has a water activity ranging from about 0.5 to 0.7.

In some instances, a twenty-fourth aspect of the disclosure can be described as a unit dose detergent product comprising a detergent composition according to any one of the first through twenty-second aspects, wherein the detergent composition has a water activity of 0.6±0.05.

In some instances, a twenty-fifth aspect of the disclosure can be described as a unit dose detergent product comprising a detergent composition according to any one of the first through twenty-second aspects, wherein the detergent composition has a water activity of 0.6±0.02.

In some instances, a twenty-sixth aspect of the disclosure can be described as a unit dose detergent product comprising a detergent composition according to any one of the first through twenty-fifth aspects, wherein the one or more nonionic and/or anionic surfactants comprises an alcohol ethoxylate.

In some instances, a twenty-seventh aspect of the disclosure can be described as a method of cleaning laundry comprising combining a unit dose detergent product according to any one of the first through twenty-sixth aspects with water, wherein the pouch dissolves in the water and the detergent composition is incorporated into the water to form a diluted detergent composition having from about 0.4 grams to about 0.8 grams of the detergent composition per liter of water, and cleaning the laundry using the diluted detergent composition.

### BRIEF DESCRIPTION OF THE DRAWINGS

In order that the present disclosure may be readily understood, aspects of the invention are illustrated by the way of examples in the accompanying drawings, in which like parts are referred to with like reference numeral throughout.

FIG. 1 is a graphical display of the buffer capabilities of sugar amines compared to lysine and triethanolamine. The pH is measured as a function of NaOH addition to the solution.

### DETAILED DESCRIPTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, alternatively ±1 percent, alternatively ±0.5 percent, and alternatively ±0.1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Various aspects of the present disclosure are directed towards unit dose detergent products and methods of using the same.

In accordance with various aspects of the disclosure, certain unit dose detergent products comprise, consist essentially of, or consist of a pouch comprising at least one chamber, the pouch made of a water-soluble material, and a detergent composition encapsulated with within the at least one chamber, the detergent composition. The detergent composition can comprise, consist essentially of, or consist of a sugar amine, a non-aqueous solvent, one or more nonionic and/or anionic surfactants, and water. Sugar amines have been found to serve as effective pH buffers, whether used alone or in combination with other known pH buffers such as, for example, triethanolamine. The inventors have further discovered that sugar amines serve as effective chlorine scavengers when used in laundry detergent compositions. This is of importance since wash water (especially water from municipal sources) contains chlorine as a sanitization agent against microbes. Chlorine deteriorates dyes in fabrics over time, which may be observed (by, for example, reduced color saturation or intensity exhibited by the fabric) in 30 washes or less if not controlled. In addition to fabric dye damage, chlorine can negatively impact the cleaning performance of enzymes that may be present in laundry detergent compositions. As such, the use of sugar amines as chlorine scavengers can help enhance enzyme cleaning performance and thus the overall cleaning efficiency of laundry detergent compositions.

Further, a suitable pH buffer is of importance to provide manufacturing facilities more flexibility for production, so it is much easier to hit the target pH, even if materials are added within a standard deviation of a target amount (for example ±2%). The inventors found the use of sugar amines can be effective in buffering liquid detergent compositions at various pH values including those in the 7 to 8 range, which is ideal for enzyme containing formulations. Within its buffer range, sugar amines can provide dual benefits (buffering and chlorine scavenging), whereas outside of the buffer range, it provides a chlorine scavenging benefit.

A unit dose pack is formed by encapsulating a detergent composition within a container, where the container is made in part or completely of a film. In some instances, the film forms a portion, such as one half, or more of the container. In some instances, the container may also include dyes, print, or other components in or on a surface of the container. The film is water soluble such that the film will completely dissolve when exposed to water, such as in a washing machine typically used for laundry. When the film dissolves, the container ruptures and the contents are released. As used herein, “water soluble” means at least 2 grams of the solute (the film in one example) will dissolve in 5 liters of water, for a solubility of at least 0.4 grams per liter (gift at a temperature of 25 degrees Celsius (° C.) unless otherwise specified. Suitable films for packaging are rapidly and completely soluble in water at temperatures of about 5° C. or greater.

In some instances, the film is desirably strong, flexible, shock resistant, transparent, and non-tacky during storage at both high and low temperatures and high and low humidity. In some instances, the film is initially formed from polyvinyl acetate, and at least a portion of the acetate functional groups are hydrolyzed to produce alcohol groups. Therefore, the film includes polyvinyl alcohol (PVOH), and may include a higher concentration of PVOH than polyvinyl acetate. Such films are commercially available with various levels of hydrolysis, and thus various concentrations of PVOH. In some instances, the film initially has about 85 to about 90 percent of the acetate groups hydrolyzed to alcohol groups, but other percentages of hydrolysis are also possible in alternate embodiments. In some instances, some of the acetate groups may further hydrolyze in use, so the final concentration of alcohol groups may be higher than the concentration at the time of packaging. In some instances, the film may have a thickness of from about 25 to about 200 microns (μm), alternatively from about 45 to about 100 μm, or alternatively from about 65 to about 90 μm. In some instances, the film may include alternate materials such as methyl hydroxy propyl cellulose and polyethylene oxides. Generally, the type of water soluble material used for the film is not limiting, however the type of material used for the film should be soluble in water.

In some instances, unit dose packs may be formed from a container having a single section (or “pouch”), In some instances, unit dose packs may be formed from containers with two or more different sections (or “pouches”). In some instances, when a container has two or more sections, the contents of the different sections may or may not be the same. In some instances, with two or more sections, at least one of the sections includes the detergent composition. In some instances, the other section may include the same or a different formulation of detergent composition, but in some instances the other section includes a different composition, such as a fabric softening composition or other fabric treatment. In some instances, the unit dose pack is formulated and configured for cleaning laundry, but other cleaning purposes are also possible. In some instances, the detergent composition is positioned within the container, and the container is sealed to encapsulate and enclose the detergent composition. In some instances, the detergent composition is in direct contact with the film of the container within the unit dose pack. In some instances, the film of the container is sealable by heat, a combination of heat and water, ultrasonic methods, or other suitable techniques. In some instances, a combination of sealing techniques may be used to enclose the detergent composition within the container. In some instances, the water-soluble material is a polyvinyl alcohol. In some instances, the water-soluble material is a polyethylene terephthalate. In some instances, the water-soluble material is a polyethylene, a polypropylene or a polyvinyl chloride.

As used herein, the term “sugar amine” is directed to a broad class of compounds. In some instances, sugar amines suitable for use in liquid detergent compositions according to the disclosure are monosaccharides, in cyclic or open chain form, where at least three, alternatively at least two, alternatively at least one, alternatively three, alternatively two, alternatively one, and preferably one, hydroxyl group has been substituted with a secondary or primary amine, preferably a primary amine. Example monosaccharides include, but are not limited to glucose, fructose, galactose, mannofuranose (i.e., mannose in five-membered ring form) and mannopyranose. By extension example sugar amines having a monosaccharide base structure may include, for example, glucosamine, galactosamine, N-acetylglucosamine, duanosamine, frustosamine, mannosamines, glucose diamines (for example, 2,6-diamino-2,3,6-trideoxy-alpha-D-glucose), and so on.

In some instances, sugar amines suitable for use in liquid detergent compositions according to the disclosure are disaccharides where at least three, alternatively at least two, alternatively at least one, alternatively three, alternatively two, alternatively one, and preferably one, hydroxyl group on one or both saccharide units has been substituted with a secondary or primary amine, preferably a primary amine. Example disaccharides include, but are limited to sucrose, lactose, maltose, trehaloses, cellobiose, chitobiose, kojibiose, nigerose, isomaltose, sophorose, laminaribiose, gentiobiose, trehalulose, turanose, maltulose, leucrose, isomaltulose, gentiobiulose, mannobiose, melibiose, allolactose, melibiulose, lactulose, rutinose, rutinulose and xylobiose. By extension example sugar amines having a disaccharide base structure may include, for example, lactosamine, N-acetyllactosamine, trehalosamines (for example, 2-trehalosamine, 3-trehalosamine and 4-trehalosamine), a glucosamine disaccharide form of chitobiose, an N,N′-diacetylglucosamine dimer form of chitobiose, and so on.

In some instances, sugar amines suitable for use in liquid detergent compositions according to the disclosure are sugar alcohols where at least three, alternatively at least two, alternatively at least one, alternatively three, alternatively two, alternatively one, and preferably one, hydroxyl group of the sugar alcohol has been substituted with a secondary or primary amine, preferably a primary amine. Example sugar alcohols include, but are not limited to sorbitol, xylitol, mannitol, erythritol, threitol, arabitol, ribitol, galactitol, fucitol, iditol, inositol, volemitol, maltitol, and lactitol. By extension example sugar alcohol amines may include, for example, sorbitol amine, mannitol amine, and so on.

In some instances, detergent compositions according to various aspects of the disclosure may include a sugar amine in an amount ranging from about 0.025 to about 2 wt % of the detergent composition. In some instances, the sugar amine is in an amount ranging from about 0.01 to about 10 wt %, alternatively from about 0.01 to about 8 wt %, alternatively from about 0.01 to about 6 wt %, alternatively from about 0.01 to about 5 wt %, alternatively from about 0.01 to about 4 wt %, and alternatively from about 0.01 to about 2 wt % of the detergent composition. In some instances, the sugar amine is in an amount ranging from about 0.05 to about 1.75, alternatively from about 0.075 to about 1.5 wt %, alternatively from about 0.1 to about 1.25 wt %, alternatively from about 0.15 to about 1.0 wt %, alternatively from about 0.2 to about 1 wt %, and alternative from about 0.25 to about 0.75 wt % of the detergent composition. The sugar amine can be any compound as described above, a salt thereof, or any combination of one or more sugar amines and/or sugar amine salts. In some instances, the use of glucosamine, sorbitol amine, glucose diamines, salts thereof, or any combination of any of the foregoing as the sugar amine is preferred. In some instances, the use of glucosamine HCl as the sugar amine is preferred.

In some instances, detergent compositions according to various aspects of the disclosure may include a non-aqueous solvent in an amount ranging from about 15 to about 65% of the detergent composition. In some instances, the non-aqueous solvent is in an amount ranging from about 17.5 to about 62.5 wt %, alternatively from about 20 to about 60 wt %, alternatively ranging from about 20 to about 57.5 wt %, alternatively ranging from about 20 to about 55 wt %, alternatively ranging from about 22.5 to about 52.5 wt %, and alternatively ranging from about 25 to about 50 wt % of the detergent composition.

As used herein, the term “non-aqueous solvent” is directed towards a broad class of compounds. In some instances, the non-aqueous solvent is one or a combination of a polyol (i.e., a hydrocarbon having more than one hydroxyl group such as glycerol (glycerin), propylene glycol and ethylene glycol), an alcohol (such as ethanol), and a 4C+ compound. As used herein, a “4C+ compound” refers to an organic compound having 4 or more carbons and at least one oxygen group (for example, an alcohol, ether, ester, alkoxy, and so on). As such, certain 4C+ compounds may also be alcohols or polyols with at least four carbons. In some instances, suitable 4C+ compounds include, but are not limited to, one or more of: polypropylene glycol; polyethylene glycol esters such as polyethylene glycol stearate, propylene glycol laurate, and/or propylene glycol palmitate; ethyl ester ethoxylate; diethylene glycol; dipropylene glycol; tetramethylene glycol; butylene glycol; pentanediol; hexylene glycol; heptylene glycol; octylene glycol; 2-methyl, 1,3-propanediol; triethylene glycol; polypropylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methylsulfate; ethylene oxide/propylene oxide copolymers with a number average molecular weight of 3,500 Daltons or less; and ethoxylated fatty acids. In some instances, the non-aqueous solvent is or includes a relatively low molecular weight polyethylene glycol (PEG). In some instances, the polyethylene glycol has a molecular weight ranging from about 200 to about 1000 g/mol (or Daltons), alternatively a molecular weight ranging from about 200 to about 800 g/mol, or alternatively a molecular weight of about 400 g/mol. In some instances, the polyethylene glycol has a weight average molecular weight of less than about 600 Da, e.g. about 400, such as those having a weight average molecular weight of from about 380 to about 420 Da. In other instances, PEG 200, PEG 250, PEG 300, PEG 350, PEG 400, PEG 450, PEG 500, PEG 550, and/or PEG 600 (wherein the numerals represent the approximate weight average molecular weight in Daltons or grams/mol) may be used. In some instances, the non-aqueous solvent is or includes an ethylene oxide/propylene oxide block copolymer. In some instances, the non-aqueous solvent is or includes a polyol such as glycerin. In some instances, the non-aqueous solvent is or includes a mixture of a polyol and a polyethylene glycol. In some instances, the polyol in the mixture is glycerin. Suitable polyol/polyethylene glycol mixtures may have a polyol to polyethylene glycol weight:weight ratio ranging from about 10:1 to about 1:10, alternatively from about 9:1 to about 1:9, alternatively from about 8:1 to about 1:8, alternatively from about 7:1 to about 1:7, alternatively from about 6:1 to about 1:6, alternatively from about 5:1 to about 1:5, alternatively from about 4:1 to about 1:4, alternatively from about 3:1 to about 1:3, alternatively from about 2:1 to about 1:2, alternatively from about 1.5:1 to about 1:1.5, and alternatively about 1:1.

In some instances, detergent compositions according to various aspects of the disclosure may include one or more nonionic and/or anionic surfactants in an amount ranging from about 15 to about 55 wt % of the detergent composition. In some instances, the one or more nonionic and/or anionic surfactants are in an amount ranging from about 15 to about 50 wt %, alternatively from about 15 to about 45 wt %, alternatively from about 15 to about 40 wt %, alternatively from about 20 to about 40 wt %, alternatively from about 20 to about 35 wt %, and alternatively from about 20 to about 30 wt % of the detergent composition.

Various classes of nonionic surfactants may be used. In some instances, suitable nonionic surfactants include, but are not limited to, alkoxylated alcohols, polyoxyalkylene alkyl ethers, polyoxyalkylene alkylphenyl ethers, polyoxyalkylene sorbitan fatty acid esters, polyoxyalkylene sorbitol fatty acid esters, polyalkylene glycol fatty acid esters, alkyl polyalkylene glycol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, alkylamine oxides, or any combinations thereof.

Various classes of anionic surfactants may be used. In some instances, the anionic surfactant can be a linear alkyl sulfonate (LAS) or a linear alkylbenzene sulfonate (LABS). LAS and LABS are water soluble salts between 8 and 22 carbon atoms in the alkyl group. In some instances, suitable LAS and/or LABS compounds may include salts of C₈-C₁₈ alkyl sulfonic acids and salts of C₈-C₁₈ alkylbenzyl sulfonic acids. In some instances, the anionic surfactant is a linear alkyl ether (or laureth) sulfonate. In some instances, suitable linear alkyl ether sulfonates include a linear C₈-C₁₈ alkyl chain, 4-9 repeating ethylene oxide units, and an anionic head group made up of the sulfonate group and a counter cation. Suitable counter cations for LAS, LABS and linear alkyl ether sulfonates can be, but are not necessarily limited to, Na⁺, K⁺, and NH₄⁺. In some instances, the anionic surfactant is sodium or potassium lauryl sulfate or a sodium or potassium lauryl ether sulfate.

In some instances, detergent compositions according to various aspects of the disclosure may further comprise a fatty acid. In some instances, the fatty acid is in an amount ranging from about 2 to about 10 wt % of the detergent composition. In some instances, the fatty acid is in an amount ranging from about 1 to about 12 wt % of the detergent composition. In some instances, the fatty acid is coconut fatty acid. In some instances, the fatty acid may be one of lauric acid, myristic acid, palmitic acid, stearic acid, ricinoleic acid, oleic acid, linoleic acid, or linolenic acids.

In some instances, detergent compositions according to various aspects of the disclosure may further comprise a lauryl sulfate and/or a lauryl ether sulfate. In some instances, the lauryl sulfate and/or lauryl ether sulfate is in an amount ranging from about 2 to about 8 wt % of the detergent composition.

In some instances, detergent compositions according to various aspects of the disclosure may further comprise a bittering agent to hinder accidental ingestion of the composition. Bittering agents are compositions that taste bad, so children or others are discouraged from accidental ingestion. Generally, the type of bittering agent used is not limited to any particular compounds. Suitable bittering agents include, but are limited to denatonium benzoate, denatonium saccharide, sucrose octaacetate, capsicum, aloin, or others. In some instances, the bittering agent is in an amount ranging from about 0.01 to about 0.5 wt % of the detergent composition. In some instances, the bittering agent is in an amount ranging from about 0.015 to about 0.4 wt %, alternatively from about 0.02 to about 0.3 wt %, alternatively from about 0.025 to about 0.2 wt %, alternatively from about 0.03 to about 0.1 wt %, alternatively from about 0.035 to about 0.075 wt %, and alternatively from about 0.04 to about 0.06 wt % of the detergent composition.

In some instances, unit dose products comprising a detergent composition according to various aspects of the disclosure may further comprise an alcohol or a denatured alcohol. In some instances, the denatured alcohol is a denatured alcohol ranging from 140 to 200 proof, alternatively from 160 to 200 proof, and alternatively from 180 to 200 proof. In some instances, the denatured alcohol is in an amount ranging from about 0.5 to about 6 wt % of the detergent composition. In some instances, the denatured alcohol is in an amount ranging from about 1 to about 5 wt %, alternatively from about 2 to about 4 wt %, and alternatively from about 2.5 to about 3.5 wt % of the detergent composition.

In some instances, the unit dose detergent product comprising a detergent composition according to various aspects of the disclosure may further comprise a chelating agent. In some instances, the chelating agent is in an amount ranging from about 0.1 to about 2 wt % of the detergent composition. In some instances the chelating agent is iminodisuccinic acid, ethylenediaminetetraacetic acid (EDTA), nitrilotriacetic acid, diethylenetriaminepenta(methylenephosphonic acid), nitrilotris(methylenephosphonic acid), 1-hydroxyethane-1,1-diphosphonic acid, ethylenediamine-N,N′-disuccinic acid (EDDS), hydroxyethylenediaminetriacetic acid (HEDTA), N,N-bis(carboxymethyl)-L-glutamic acid, Alaine, N,Nbis(carboxymethyl)-alanine, trisodium salt, any suitable salts thereof of these acids, or other suitable chelating compounds.

In some instances, detergent compositions according to various aspects of the disclosure may include a preservative. In some instances, the preservative is in an amount ranging from about 0.05 to about 2 wt % of the detergent composition. In some instances, the preservative is one or more of a microbiocide, an algicide, and a fungicide. In some instances, the preservative is a mixture of 5-chloro-2-methyl-2H-isothiazol-3-one and 2-methylisothiazol-3 (2H)-one and 1,2-benzisothiazol-3 (2H)-one. In some instances, preservative is methylisothiazolinone, chloromethylisothiazolinone, benzisothiazolinone, sorbic acid, sodium benzoate, formaldehyde, borate, and glutaraldehyde. In some instances, detergent compositions according to various aspects of the disclosure may be free of, or substantially free of, preservatives.

In some instances, detergent compositions according to various aspects of the disclosure may include an aqueous enzyme solution comprising a cocktail of one or more enzymes. In some instances, the one or more enzymes may include, for example, one or more of a protease, a mannanase, or an amylase. In some instances, the aqueous enzyme solution is in an amount from about 1 to about 5 wt % of the detergent composition. In some instances, the aqueous enzyme solution is in an amount ranging from 0.01 to about 10 wt %, alternatively 1 to about 8 wt %, alternatively 2 to about 6 wt %, or alternatively about 1 to about 3 wt % of the detergent composition.

In some instances, detergent compositions according to various aspects of the disclosure may further comprise a strong base. In some instances, the strong base is an amount ranging from about 0.5 to about 5 wt % of the detergent composition. In some instances, the amount of the strong base is from about 0.5 to about 2.5 wt %, alternatively from about 0.5 to about 2 wt %, alternatively from about 0.5 to about 1.5 wt %, and alternatively from about 0.5 to about 1 wt % of the detergent composition. In some instances, the strong base can be, for example, potassium hydroxide, sodium hydroxide, or calcium hydroxide. Generally, any amount of strong base may be added to a detergent composition to provide said detergent composition with a target end property such as, for example, pH.

In some instances, the unit dose detergent comprising a detergent composition according to various aspects of the disclosure may further comprise an effective amount of polyethylene imine ethoxylate, a polyethylene imine propoxylate, or a polyethylene imine ethoxylate/propoxylate.

In some instances, detergent compositions according to various aspects of the disclosure can further comprise an anti-redeposition polymer. In some instances, anti-redeposition agents include polymers with a soil detachment capacity, which are also known as “soil repellents” due to their ability to provide a soil-repelling finish on the treated surface, such as a fibers. In some instances, the anti-redeposition polymer is in an amount ranging from about 0.1 to about 1 wt % of the detergent composition. In some instances, the anti-redeposition polymer is an acrylic/styrene copolymer. In some instances, the polymer can be a polyester. In some instances, the polyesters include co-polyesters prepared from dicarboxylic acids, such as adipic acid, phthalic acid or terephthalic acid. In some instances, an anti-redeposition agents includes polyesters with a soil detachment capacity that include those compounds which, in formal terms, are obtainable by esterifying two monomer moieties, the first monomer being a dicarboxylic acid HOOC-Ph-COOH and the second monomer a diol HO—(CHR—)ₐOH, which may also be present as a polymeric diol H—(O—(CHR—)ₐ)_{b}OH. “Ph” here means an ortho-, meta- or para-phenylene residue that may bear 1 to 4 substituents selected from alkyl residues with 1 to 22 C atoms, sulfonic acid groups, carboxyl groups and mixtures thereof, “R” means hydrogen or an alkyl residue with 1 to 22 C atoms and mixtures thereof, “a” means a number from 2 to 6 and “b” means a number from 1 to 300. In some instances, the polyesters obtainable therefrom may contain not only monomer diol units —O—(CHR-)aO— but also polymer dial units —(O—(CHR—)ₐ)_{b}O—. In some instances, the molar ratio of monomer diol units to polymer diol units may amount to from about 100:1 to about 1:100, or alternatively from about 10:1 to about 1:10. In some instances, the polymer diol units, the degree of polymerization “b” may be in the range of from about 4 to about 200, or alternatively from about 12 to about 140. In some instances, the number average molecular weight of the polyesters with a soil detachment capacity may be in the range of from about 250 to about 100,000, or alternatively from about 500 to about 50,000. In some instances, the acid on which the residue Ph is based may be selected from terephthalic acid, isophthalic acid, phthalic acid, trimellitic acid, mellitic acid, the isomers of sulfophthalic acid, sulfoisophthalic acid and sulfoterephthalic acid and mixtures thereof. In some instances, the acid groups thereof are not part of the ester bond in the polymer, they may be present in salt form, such as an alkali metal or ammonium salt.

In some instances, instead of the monomer HOOC-Ph-COOH, polyesters with a soil detachment capacity (the anti-redeposition agent) may include small proportions, for example up to about 10 mole percent relative to the proportion of Ph with the above-stated meaning, of other acids that include at least two carboxyl groups. These include, for example, alkylene and alkenylene dicarboxylic acids such as malonic acid, succinic acid, fumaric acid, maleic acid, glutaric acid, adipic acid, pimelic acid, suberic acid, azelaic acid and sebacic acid. Exemplary diols HO—(CHR—)ₐOH include those in which R is hydrogen and “a” is a number of from about 2 to about 6, and in some instances those in which “a” has the value of 2 and R is selected from hydrogen and alkyl residues with 1 to 10 C atoms, or where R is selected from hydrogen and alkyl residues with 1 to 3 C atoms in another embodiment. Examples of diol components include ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. The polymeric diols may include polyethylene glycol with an average molar mass in the range from about 1000 to about 6000. In some instances, these polyesters may also be end group-terminated, with end groups that may be alkyl groups with 1 to 22 C atoms or esters of monocarboxylic acids. The end groups attached via ester bonds may be based on alkyl, alkenyl and aryl monocarboxylic acids with 5 to 32 C atoms, or alternatively with 5 to 18 C atoms. These may include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidic acid, oleic acid, linoleic acid, linolaidic acid, linolenic acid, eleostearic acid, arachidic acid, gadoleic acid, arachidonic acid, behenic acid, erucic acid, brassidic acid, clupanodonic acid, lignoceric acid, cerotic acid, melissic acid, benzoic acid, which may bear 1 to 5 substituents having a total of up to 25 carbon atoms, or alternatively 1 to 12 carbon atoms, for example tert-butylbenzoic acid. The end groups may also be based on hydroxymonocarboxylic acids with 5 to 22 carbon atoms, which for example include hydroxyvaleric acid, hydroxycaproic acid, ricinoleic acid, the hydrogenation product thereof, hydroxystearic acid, and ortho-, meta- and para-hydroxybenzoic acid. The hydroxymonocarboxylic acids may in turn be joined to one another via their hydroxyl group and their carboxyl group and thus be repeatedly present in an end group. The number of hydroxymonocarboxylic acid units per end group, i.e. their degree of oligomerization, may be in the range of from 1 to 50, or alternatively in the range of from 1 to 10. In some instances, polymers of ethylene terephthalate and polyethylene oxide terephthalate, in which the polyethylene glycol units have molar weights of from about 750 to about 5000 and the molar ratio of ethylene terephthalate to polyethylene oxide terephthalate of from about 50:50 to about 90:10, can be used alone or in combination with cellulose derivatives.

In some instances, the dose unit product comprising detergent composition according to various aspects of the disclosure includes sodium sulfite. Sodium sulfite is an oxygen scavenger, where sodium sulfite reacts with oxygen to form sodium sulfate. Free oxygen, such as oxygen dissolved in the detergent composition, can react to produce metal oxides (rust) that reduce the life of the washing equipment. The metal oxides can also stain garments, dishes, or other items being washed. Dissolved oxygen can also react to produce other components, and some of those components may be colored bodies. Therefore, the sodium sulfite can help reduce the formation of colored bodies in the detergent composition. However, sodium sulfite includes sodium, and sodium-containing compounds tend to produce efflorescent solids in the film. In some instances, the sodium sulfite is in an amount from about 0.05 to about 4 wt %, alternatively from about 0.05 to about 3 wt %, alternatively from about 0.05 to about 2 wt % of the detergent composition.

In some instances, the unit dose products comprising detergent compositions according to various aspects of the disclosure may include an optical brightener. Optical brighteners adsorb ultraviolet and/or violet light and re-transmit it as visible light, typically a visible blue light. Optical brighteners include, but are not limited to, derivatives of diaminostilbene disulfonic acid or alkali metal salts thereof. Suitable compounds are, for example, salts of 4,4′-bis(2-anilino-4-morpholino-1,3,5-triazinyl-6-amino) stilbene 2,2′-disulfonic acid or compounds of similar structure which, instead of the morpholino group, bear a diethanolamino group, a methylamino group, an anilino group or a 2-methoxyethylamino group. Optical brighteners of the substituted diphenylstyryl type may furthermore be present, such as the alkali metal salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the above-stated optical brighteners may also be used. In some instances, optical brighteners may be present in detergent compositions in an amount ranging about 0.01 to about 0.5 wt %, alternatively from about 0.01 to about 1 wt %, alternatively from about 0.01 to about 3 wt %, or alternatively from 0.01 to about 5 wt % of the detergent composition.

In some instances, the unit dose product comprising a detergent composition according to various aspects of the disclosure may include one or more foam inhibitors (i.e, defoamers). In some instances, foam inhibitors include, but are not limited to, fatty acids such as coconut fatty acids. In some instances, suitable foam inhibitors include, for example, soaps of natural or synthetic origin (which may exhibit elevated proportions of C₁₈-C₂₄ fatty acids), organopolysiloxanes and mixtures thereof with microfine (and optionally silanized) silica, paraffins, waxes, microcrystalline waxes and mixtures thereof with silanized silica or bis-fatty acid alkylenediamides (for example, bistearylethylenediamide), silicones, and combinations thereof. In some instances, foam inhibitors may be present in detergent compositions in an amount ranging about 0.01 to about 0.5 wt %, alternatively from about 0.01 to about 0.1 wt %, alternatively from about 0.01 to about 3 wt %, or alternatively from 0.01 to about 5 wt % of the detergent composition.

In some instances, detergent compositions according to various aspects of the disclosure can have the pH range from about 8 to about 10. In some instances, the pH of the detergent composition can range from about 5 to about 12, alternatively from about 6 to about 10, alternatively from about 7 to about 10. In some instances, it has been found that detergent compositions having a pH ranging from about 7 to about 9 are preferred in instances where a detergent composition includes one or more enzymes, as such pH range has been observed to enhance enzyme stability.

In some instances, the unit dose detergent product comprising a detergent composition according to various aspects of the disclosure, wherein the detergent composition has a water activity ranging from about 0.5 to about 0.7. In some instances, the detergent composition has a water activity of 0.6±0.02. In some instances, the water activity ranges from about 0.5 to about 1, alternatively from about 0.5 to about 0.9, alternatively about 0.5 to about 0.8, or alternatively about 0.6 to about 0.7.

Disclosed within is a method of cleaning laundry, the method comprising: combining a unit dose detergent product containing a detergent composition according to various aspects of the disclosure with water, wherein the container dissolves in the water and the detergent composition is incorporated into the water to form a diluted detergent composition having from about 0.1 to grams to about 1.5 grams, preferably from about 0.2 to about 1.25 grams, more preferably from about 0.3 to about 1 gram, and more preferably from about 0.4 to about 0.8 grams of the detergent composition per liter of water, and cleaning laundry using the diluted detergent composition.

As used herein the phrase “Zein score” refers the measurement obtained from the Zein test as described herein. It can also be referred to as “Zein solubilized %.” In some instances, the formulations described herein have a Zein score of less than about 3% when tested as a 10% dilution. In certain instances, the formulations have a Zein score of from about 0.01% to about 3%, alternatively from about 0.01% to about 2.75%, alternatively from about 0.01% to about 2.5%, alternatively from about 0.01% to about 2.25%, alternatively from about 0.01% to about 2%, alternatively from about 0.01% to about 1.75%, alternatively from about 0.01% to about 1.5%, alternatively from about 0.01% to about 1.25%, and alternatively from about 0.01% to about 1% when tested as a 10% dilution. In other instances, the formulations described herein can have a Zein score of less than about 2.75%, preferably less than about 2.5%, more preferably less than about 2.25%, even more preferably less than about 2%, even more preferably less than 1.75%, even more preferably less than about 1.5%, even more preferably less than about 1.25%, and even more preferably less than about 1% when tested as a 10% dilution.

In some instances, the detergent composition has a Zein score less than 0.5%. In some instances, the detergent composition has a Zein score ranging from about 0.3 to about 0.4%. The Zein score is used in these instances as a measurement of how mild the laundry detergent is as explained in the examples.

One method to test the skin irritancy potential of a surfactant composition is Zein test. Zein score is measured using a Zein test (Gott, E., Aesthet. Medzin., Tenside 15: 313(1966)). Zein test determines the extent of denaturation of Zein corn protein after exposure to a surfactant for a given period of time. Generally, the higher the Zein score, the greater the skin irritation potential.

Another method to measure the skin irritancy potential is corneosurfametry (CSM) test, a noninvasive quantitative test that measures the interaction between surfactants and human stratum corneum (Pierard et al., Dermatology 189:152-156 (1994)). Corneosurfametry involves removing a few layers of skin using cyanoacrylate skin surface strippings, short contact time with surfactants followed by staining the samples with fuchian dyes. A less damaged barrier allows greater penetration of the stain, therefore giving a more intense color, which is measured using colorimetrically with L * a * b * color space. This method is predictive of both protein and lipid damage in the skin. CIM (Color Indicator of Mildness) values are obtained from a corneosurfametry test. In a comparative study, the higher the CIM value, the milder the surfactant formulation.

A third method to evaluate the irritation effect of a surfactant formulation is measured by cytokine release of representative human skin model in response to the surfactant formulation. Where skin tissue viability is not decreased by 50% as compared to the negative control tissue (as measured by MTT reduction), the inflammatory potential is then measured by the production of the cytokines IL-1a. and/or IL-1ra. MTT is a dye used to stain the skin cells called 3-(4,5-dimethylthiazol-2-yl)-2,5-diphenyltetrazolium bromide. In a comparative study, a lower cytokine release value means a milder surfactant formulation.

Described in US 2018/0016523, the entire contents of which are incorporated by reference herein, are methods for determining how mild an aqueous laundry detergent formulation is for a user. The method comprises the steps of: (i) providing a solution comprising a laundry cleaning effective amount of a surfactant composition, (ii) subjecting an appropriate dilution of the solution to Zein test, corneosurfametry test, and in vitro cytokine release test for IL-1a and IL-1ra response, respectively, to obtain a Zein score, a corneosurfametric (CSM) value, and a cytokine release value, and (iii) deriving at composite mildness indicator (CMI) for each solution based the Zein score, the CSM value, and the cytokine release value.

The composite mildness indicator (CMI) may also be called detergent mildness indicator (DMI). Specifically, the CMI can be derived from (1) the Zein score, CSM value, and cytokine release value IL-1a of the formulation; (2) the Zein score, CSM value, and cytokine release value (IL-1a+IL-1ra) of the formulation; (3) the Zein score, CSM value, and cytokine release value (IL-1ra/IL-1a) of the formulation; (4) the Zein score, CSM value, and cytokine release value log 10 (IL-1ra/IL-1a) of the formulation; or (5) the Zein score, CSM value, and cytokine release measurement (IL-1a/IL-1ra) of the formulation.

### EXAMPLES

### Example 1—Sugar Amines as Chlorine Scavengers in Laundry Detergents

Formulations, i.e., Formulations 1 (control) and 2 (inventive), were prepared with the components (all amounts are in wt %) listed in Table 1.

TABLE 1

| | Formulation 1 | Formulation 2 |
|---|---|---|
| Component | (Control) | (Inventive) |
| Glycerin | 25.60 | 25.10 |
| Alcohol Ethoxylate Nonionic | 23.07 | 23.07 |
| Surfactant, 7 mol EO | | |
| Propylene Glycol | 0 | 0 |
| Polyethylene Glycol (400 g/mol) | 23.18 | 23.18 |
| Water | 10.5 | 10.5 |
| Coconut Fatty Acid | 6 | 6 |
| Sodium Laureth Sulfate, 3 mole EO | 4.8 | 4.8 |
| Glucosamine HCl | 0 | 0.5 |
| Sodium Sulfite 15% Solution, | 3.85 | 3.85 |
| Bittering Agent (25% active), | | |
| Iminodisuccinic Acid (34% active), | | |
| 50% Sodium Hydroxide | | |
| SDA-3C Ethanol (200 Proof) | 3 | 3 |

The target dose of detergent per wash was 18.8 grams, and the estimated amount of water in a High Efficiency Washing Machine was 31.4 L. Proportionally, 0.6 grams of detergent was added into 1 L of water for benchtop scale.

With a starting chlorine concentration of 1 ppm in the water, the following results were gained after adding 0.6 grams of Formula 1 and 2 to 1 liter of 1 ppm chlorinated water:

TABLE 2

| | | Start | 15 | 30 | 1 | 2 |
|---|---|---|---|---|---|---|
| | | ppm | Seconds | Seconds | minute | minutes |
| 0.6 g | Control | 1 | 1 | 1 | 0.5 | 0.5 |
| in 1 L | (Formulation 1) | | | | | |
| | Formulation 2 | 1 | 0 | 0 | 0 | 0 |

Each of formulations 1 and 2 had viscosity of about 150 cP at 25 C.

Enzymes and polymers known to the art, such as protease, mannanase and amylase (among others) can be added to formulations 1 and 2, to improved washing efficacy as well as performance polymers such as polyethylene imines or anti-redeposition polymers. The formulations in Example 1 can be further enclosed within polyvinyl alcohol film, standard to the industry, to create unit dose detergent packs. The improvement in chlorine scavenging efficacy can be observed with Formula 2, with Formula 2 scavenging all chlorine within 15 seconds vs the Control (Formula 1) not scavenging any chlorine until 1 minute. Formula 1 was only capable of scavenging half of the chlorine as well.

### Example 2—Sugar Amines Act as pH Buffers

Monoethanolamine has been observed to suitably buffer solutions from pH 7 to 9. As observed in the example below, Glucosamine buffers from pH 6.8 to 8.6. The following example compare TEA, Glucosamine and Lysine (pH 9-10)'s buffering capabilities.

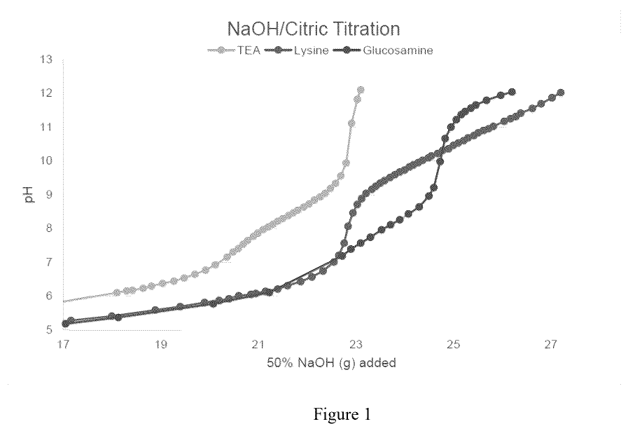

Three solutions of 350 grams of deionized water, 35 grams of 50% citric acid in water, and then 5 grams of active triethanolamine (TEA), lysine (from Lysine HCl (99% active)), and Glucosamine (from Glucosamine HCl (99% Active)) were prepared for a titration with 50% NaOH in water. This system simulates the main acidic and basic components of a liquid laundry detergent to measure what pH Glucosamine can buffer effectively compared to the historical use of triethanolamine. The following results were observed, as set forth in Table 3 and FIG. 1.

TABLE 3

| TEA | | Lysine HCl | | Glucosamine HCl | |
|---|---|---|---|---|---|
| 50% NaOH | | 50% NaOH | | 50% NaOH | |
| Added (g) | pH | Added | pH | Added | pH |
| 2.87 | 3.35 | 1.36 | 2.58 | 2.28 | 2.50 |
| 5.16 | 3.78 | 2.5 | 2.76 | 5.6 | 3.19 |
| 7.55 | 4.21 | 3.9 | 3 | 7.23 | 3.51 |
| 10 | 4.59 | 5.24 | 3.25 | 9.62 | 3.95 |
| 12.55 | 5 | 6.5 | 3.47 | 12.5 | 4.42 |
| 15.39 | 5.44 | 7.6 | 3.67 | 15.44 | 4.90 |
| 18.1 | 6.1 | 9.1 | 3.94 | 17.05 | 5.17 |
| 18.3 | 6.15 | 10.17 | 4.12 | 18.13 | 5.36 |
| 18.42 | 6.17 | 11.75 | 4.38 | 20.08 | 5.76 |
| 18.64 | 6.23 | 12.6 | 4.51 | 21.23 | 6.10 |
| 18.81 | 6.29 | 14 | 4.73 | 22.72 | 7.18 |
| 19.04 | 6.37 | 15.4 | 4.97 | 22.9 | 7.38 |
| 19.27 | 6.44 | 16.16 | 5.1 | 23.1 | 7.56 |
| 19.48 | 6.53 | 17.16 | 5.27 | 23.3 | 7.73 |
| 19.7 | 6.64 | 18 | 5.4 | 23.53 | 7.95 |
| 19.92 | 6.76 | 18.89 | 5.58 | 23.71 | 8.10 |
| 20.12 | 6.92 | 19.4 | 5.68 | 23.9 | 8.25 |
| 20.36 | 7.15 | 19.9 | 5.8 | 24.08 | 8.42 |
| 20.48 | 7.3 | 20.2 | 5.86 | 24.3 | 8.63 |
| 20.59 | 7.4 | 20.4 | 5.91 | 24.5 | 8.95 |
| 20.69 | 7.53 | 20.6 | 6 | 24.6 | 9.20 |
| 20.78 | 7.64 | 20.85 | 6.04 | 24.73 | 9.97 |
| 20.9 | 7.76 | 20.95 | 6.07 | 24.83 | 10.65 |
| 20.99 | 7.85 | 21.15 | 6.13 | 24.95 | 10.99 |
| 21.1 | 7.96 | 21.4 | 6.2 | 25.06 | 11.21 |
| 21.2 | 8.04 | 21.6 | 6.3 | 25.16 | 11.36 |
| 21.3 | 8.12 | 21.87 | 6.42 | 25.24 | 11.45 |
| 21.4 | 8.21 | 22.1 | 6.56 | 25.36 | 11.55 |
| 21.5 | 8.29 | 22.33 | 6.73 | 25.46 | 11.64 |
| 21.62 | 8.38 | 22.55 | 7 | 25.68 | 11.78 |
| 21.72 | 8.46 | 22.65 | 7.2 | 25.97 | 11.93 |
| 21.81 | 8.54 | 22.76 | 7.56 | 26.2 | 12.03 |
| 21.93 | 8.63 | 22.84 | 8.06 | | |
| 22.04 | 8.72 | 22.94 | 8.45 | | |
| 22.15 | 8.83 | 23.03 | 8.7 | | |
| 22.27 | 8.93 | 23.12 | 8.87 | | |
| 22.37 | 9.04 | 23.21 | 9.03 | | |
| 22.48 | 9.18 | 23.33 | 9.15 | | |
| 22.58 | 9.33 | 23.41 | 9.24 | | |
| 22.69 | 9.55 | 23.5 | 9.33 | | |
| 22.8 | 9.93 | 23.59 | 9.41 | | |
| 22.91 | 11.11 | 23.7 | 9.5 | | |
| 23.03 | 11.81 | 23.8 | 9.58 | | |
| 23.1 | 12.1 | 23.9 | 9.66 | | |
| | | 24 | 9.72 | | |
| | | 24.1 | 9.81 | | |
| | | 24.18 | 9.87 | | |
| | | 24.28 | 9.94 | | |
| | | 24.37 | 10.01 | | |
| | | 24.49 | 10.08 | | |
| | | 24.55 | 10.14 | | |
| | | 24.68 | 10.21 | | |
| | | 24.78 | 10.3 | | |
| | | 24.9 | 10.35 | | |
| | | 25 | 10.45 | | |
| | | 25.1 | 10.52 | | |
| | | 25.21 | 10.59 | | |
| | | 25.3 | 10.67 | | |
| | | 25.42 | 10.74 | | |
| | | 25.51 | 10.82 | | |
| | | 25.62 | 10.89 | | |
| | | 25.72 | 10.94 | | |
| | | 25.82 | 11.01 | | |
| | | 26.04 | 11.16 | | |
| | | 26.17 | 11.24 | | |
| | | 26.28 | 11.3 | | |
| | | 26.38 | 11.4 | | |
| | | 26.62 | 11.54 | | |
| | | 26.8 | 11.68 | | |
| | | 27.02 | 11.86 | | |
| | | 27.2 | 12.01 | | |

Although the present invention and its objects, features and advantages have been described in detail, other embodiments are encompassed by the invention. All references cited herein are incorporate by reference in their entireties. Finally, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A unit dose detergent product comprising:
a pouch comprising at least one chamber, the pouch made of a water-soluble material; and
a detergent composition encapsulated within the at least one chamber, the detergent composition comprising:
a sugar amine in an amount ranging from about 0.025 to about 2 wt % of the detergent composition;
a non-aqueous solvent in an amount ranging from about 15 to about 65 wt % of the detergent composition;
one or more nonionic and/or anionic surfactants in an amount ranging from about 15 to about 55 wt % of the detergent composition; and
water.

2. The unit dose detergent product of claim 1, wherein the detergent composition further comprises:
a fatty acid in an amount ranging from about 1 to about 10 wt % of the detergent composition;
a lauryl sulfate and/or a lauryl ether sulfate in an amount ranging from about 2 to about 8 wt % of the detergent composition;
a bittering agent in an amount ranging from about 0.01 to about 0.5 wt % of the detergent composition; and
a denatured alcohol in an amount ranging from about 0.5 to about 6 wt % of the detergent composition.

3. The unit dose detergent product of claim 2, wherein the detergent composition further comprises a chelating agent in an amount ranging from about 0.1 to about 2 wt % of the detergent composition.

4. The unit dose detergent product of claim 1, wherein the sugar amine is glucosamine, sorbitol amine, a glucose diamine, a salt thereof, or any combination of any of the foregoing.

5. The unit dose detergent product of claim 1, wherein the sugar amine is glucosamine HCl.

6. The unit dose detergent product of claim 1, wherein the sugar amine is in an amount ranging from about 0.25 to about 0.75 wt % of the detergent composition.

7. The unit dose detergent product of claim 1, further comprising at least one of a protease, a mannanase, and an amylase.

8. The unit dose detergent product of claim 1, wherein the detergent composition further comprises a strong base in an amount ranging from about 0.5 to about 5 wt % of the detergent composition.

9. The unit dose detergent product of claim 8, wherein the strong base is sodium hydroxide.

10. The unit dose detergent product of claim 1, wherein the water-soluble material is a polyvinyl alcohol.

11. The unit dose detergent product of claim 1, wherein the detergent composition has a pH ranging from about 6.5 to about 10.

12. The unit dose detergent product of claim 1, further comprising a polyethylene imine ethoxylate, a polyethylene imine propoxylate or a polyethylene imine ethoxylate/propoxylate.

13. The unit dose detergent product of claim 1, further comprising an anti-redeposition polymer.

14. The unit dose detergent product of claim 1, wherein the non-aqueous solvent comprises glycerin.

15. The unit dose detergent product of claim 14, wherein the non-aqueous solvent comprises a polyethylene glycol.

16. The unit dose detergent product of claim 15, wherein the polyethylene glycol has
a molecular weight ranging from about 200 to about 1000 g/mol,
a molecular weight ranging from about 200 to about 800 g/mol, or
a molecular weight of about 400 g/mol.

17. The unit dose detergent product of claim 1, wherein the detergent composition has a water activity ranging from about 0.5 to about 0.7.

18. The unit dose detergent product of claim 1, wherein the detergent composition has a water activity of 0.6±0.02.

19. The unit dose detergent product of claim 1, wherein the one or more nonionic and/or anionic surfactants comprises an alcohol ethoxylate.

20. A method of cleaning laundry, the method comprising:
combining a unit dose detergent product according claim 1 with water, wherein the pouch dissolves in the water and the detergent composition is incorporated into the water to form a diluted detergent composition having from about 0.4 grams to about 0.8 grams of the detergent composition per liter of water; and
cleaning laundry using the diluted detergent composition.
